(19) United States
(12) Patent Application Publication
(10) Pub. No.: US 2025/0372100 A1
(43) Pub. Date: Dec. 4, 2025

(54) SPEECH RECOGNITION MODEL LEARNING APPARATUS, SPEECH RECOGNITION MODEL LEARNING METHOD, AND PROGRAM

(71) Applicant: NIPPON TELEGRAPH AND TELEPHONE CORPORATION, Tokyo (JP)

(72) Inventors: Takafumi MORIYA, Tokyo (JP); Hiroshi SATO, Tokyo (JP); Marc DELCROIX, Tokyo (JP); Tsubasa OCHIAI, Tokyo (JP)

(73) Assignee: NIPPON TELEGRAPH AND TELEPHONE CORPORATION, Tokyo (JP)

(21) Appl. No.: 18/874,008

(22) PCT Filed: Jun. 17, 2022
(86) PCT No.: PCT/JP2022/024344

§ 371 Date: Dec. 11, 2024

(51) Int. Cl. G10L 17/18; G10L 17/02

(52) U.S. Cl. CPC G10L 17/18; G10L 17/02

(57) ABSTRACT

A speech recognition model learning apparatus includes a first voice conversion unit converting an auxiliary feature amount X_{A} into an auxiliary intermediate feature amount H_{A}, using a first multilayer neural network, a second voice conversion unit receiving, as inputs, H_{A} and a mixed sound feature amount X_{M} and converting the feature amounts into a target speaker intermediate feature amount H_{S} using a second multilayer neural network, a symbol conversion unit converting a symbol feature amount c into an intermediate character feature amount C using a third multilayer neural network, an estimation unit receiving H_{S} and C as inputs and calculating an output probability distribution Y using the neural network, a loss calculation unit receiving C_{T} and Y as inputs and calculating a loss L_{RNN-T}, and an update unit updating model parameters of the first and second voice conversion unit, the symbol conversion unit, and an estimation unit using L_{RNN-T}.

### TECHNICAL FIELD

The present disclosure relates to a learning apparatus, a speech recognition model learning method, and a program in a speech recognition model that directly outputs an arbitrary character string (phonemes, letters, sub-words, words) representing utterance content of a target speaker from multiple people's voices.

### BACKGROUND ART

In recent speech recognition systems using a neural network, it is possible to directly output a word sequence from a voice feature amount. In the learning of the Recurrent Neural Network Transducer (RNN-T) model, the correspondence between the voice and the output sequence can be dynamically learned from the learning data if phonemes, characters, subwords, and word sequences (≠frame-by-frame) corresponding to the contents of the voice are prepared by introducing the “blank” symbol representing redundancy. In other words, it is possible to learn by using a feature amount and a label having a non-corresponding relationship (generally T>>U) between the input length T and the output length U (for example, see Non Patent Literature 1). Since the inference processing of a word sequence can be performed by frame-by-frame, it has attracted attention as a technology capable of performing speech recognition while speaking is being performed (capable of performing speech recognition in real time).

In addition, there is a technique for extracting a voice of a target speaker from mixed voices using a voice of the target speaker registered in advance as a clue when a mixed voice including utterances of a plurality of speakers is input (see, for example, Non Patent Literature 2).

### CITATION LIST

### Non Patent Literature

Non Patent Literature 1: Alex Graves, “Sequence Transduction with Recurrent Neural Networks”, in Proc. of International Conference on Machine Learning (ICML), 2012.
Non Patent Literature 2: K. Zmolikova et. al., “SpeakerBeam: Speaker Aware Neural Network for Target Speaker Extraction in Speech Mixtures”, IEEE Journal of Selected Topics in Signal Processing, vol. 13, no. 4, pp. 800-814, 2019.

### SUMMARY OF INVENTION

### Technical Problem

However, the technique of extracting the voice of the target speaker from the mixed voice mentioned above requires a large amount of calculation for extracting the voice of the target speaker. Therefore, if the target speaker extraction technology is directly applied to the speech recognition technique of the RNN-T described above, a response delay occurs in the step of the speech recognition processing, and there is a problem that the advantage of real-time processing, which is a feature of the RNN-T, cannot be obtained.

Therefore, the present disclosure has been made to solve the above problems, and it is an object of the present disclosure to provide a technology capable of recognizing a voice of a target speaker in real time from mixed voices including utterances of a plurality of speakers while maintaining a delay amount at a level equivalent to that of a conventional speech recognition system by including a function of converting a distributed representation sequence of a voice corresponding to target speaker extraction in a speech recognition model.

### Solution to Problem

In order to solve the above problem, a speech recognition model learning apparatus of an aspect of the present disclosure includes a first voice conversion unit that converts an auxiliary feature amount, which is a feature amount sequence of a voice of a target speaker, into an auxiliary intermediate feature amount, using a first multilayer neural network, a second voice conversion unit that receives, as inputs, the auxiliary intermediate feature amount and a mixed sound feature amount which is a feature amount sequence of voices of a plurality of speakers and converts the auxiliary intermediate feature amount and the mixed sound feature amount into a target speaker intermediate feature amount that is an intermediate feature amount sequence of the target speaker using a second multilayer neural network, a symbol conversion unit that converts a symbol feature amount that is a symbol sequence of the target speaker into an intermediate character feature amount that is a feature amount of corresponding continuous values, using a third multilayer neural network, an estimation unit that receives, as inputs, the target speaker intermediate feature amount and the intermediate feature amount sequence and calculates an output probability distribution of a two-dimensional matrix for label estimation using a neural network, a loss calculation unit that receives, as inputs, a correct symbol that is a symbol sequence of the target speaker corresponding to correct data and an output probability distribution Y and calculates a loss corresponding to an error of the output probability distribution, and an update unit that updates model parameters of the first voice conversion unit, the second voice conversion unit, the symbol conversion unit, and the estimation unit using the loss.

### Advantageous Effects of Invention

According to the present disclosure, a voice of a target speaker can be recognized in real time from among mixed voices including utterances of a plurality of speakers.

### BRIEF DESCRIPTION OF DRAWINGS

FIG. 1 is a diagram for describing Prior Art 1.

FIG. 2 is a diagram for describing Prior Art 2.

FIG. 3 is a diagram illustrating a functional configuration example of a speech recognition model learning apparatus according to a first embodiment.

FIG. 4 is a diagram illustrating a processing flow example of a speech recognition model learning method according to the first embodiment.

FIG. 5 is a diagram illustrating a functional configuration example of a speech recognition model learning apparatus according to a modification example of the first embodiment.

FIG. 6 is a diagram illustrating a processing flow example of a speech recognition model learning method according to the modification example of the first embodiment.

FIG. 7 is a diagram illustrating a functional configuration of a computer.

### DESCRIPTION OF EMBODIMENTS

### <Character Representation>

The symbol “\hat{ }” (superscripted caret) used in the text would normally be written immediately above the immediately following character, but is written immediately before the character due to limitations of text notation. In a mathematical formula, these symbols are placed in the rightful positions, that is, directly above the characters. For example, “\hat{ }S” is expressed by the following expression in the mathematical expression.

$$\hat{S} \qquad [ Math . 1 ]$$

In addition, a symbol “˜” (superscripted tilde) used in this specification is also written immediately before the character. In a mathematical formula, these symbols are placed in the rightful positions, that is, directly above the characters. For example, “˜C” is expressed by the following expression in the mathematical expression.

$$\tilde{C} \qquad [ Math . 2 ]$$

Hereinafter, components having the same functions will be denoted by the same reference numerals, and redundant description will be omitted.

An embodiment of the present disclosure is a technology that enables real-time recognition of the target speaker's voice from mixed speech that includes utterances from a plurality of speakers by providing a function of converting a distributed representation sequence of a voice corresponding to target speaker extraction in a speech recognition model. In describing an embodiment of the detailed description of the present disclosure, first, a neural network learning method for speech recognition and a target speaker voice extraction method in the prior art will be described.

### (Neural Network Learning Method for Speech Recognition in Prior Art)

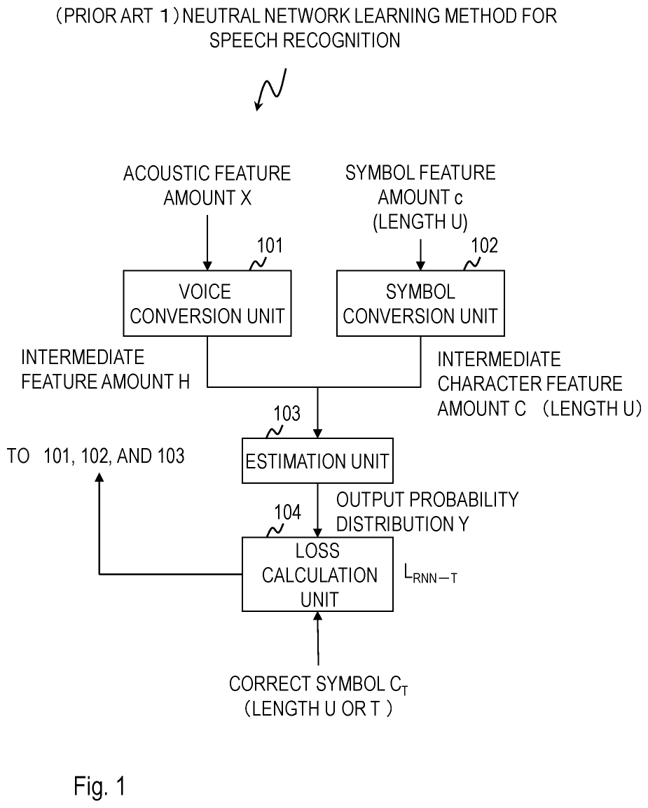

As a method of learning an acoustic model using a general neural network learning method, “Recurrent Neural Network Transducer” of Non Patent Literature 1 is known (hereinafter, this method is also referred to as “Prior Art 1”.). FIG. 1 is a functional configuration diagram of a speech recognition model learning apparatus using this method.

An acoustic feature amount X, which is a feature amount sequence of voice, is converted into a distributed representation sequence via a voice conversion unit 101 having a multilayer neural network function, and becomes an intermediate feature amount H, which is a sequence of acoustic feature amounts used for estimation of speech recognition. Furthermore, a symbol feature amount c that is a sequence of symbols corresponding to the acoustic feature amount X and has the length U is converted into a distributed representation sequence via the symbol conversion unit 102 having a multilayer neural network function, and becomes an intermediate character feature amount C that is a sequence of feature amounts of corresponding continuous values.

The intermediate feature amount H and the intermediate character feature amount C are input to a label estimation unit 103 having a neural network function, and an output probability distribution Y corresponding to label estimation that is speech recognition is calculated.

The calculated output probability distribution Y is input to a loss calculation unit 104 together with the correct symbol Cr having a length U or T that is a sequence of correct symbols, and a loss L_{RNN-T} using a predetermined calculation formula is calculated. The calculated loss L_{RNN-T} is used to update the model parameters of the voice conversion unit 101, the symbol conversion unit 102, and the estimation unit 103. Learning is performed so that speech recognition can be performed more correctly by repeating the above-described update of the model parameters.

### (Target Speaker Voice Extraction Method in Prior Art)

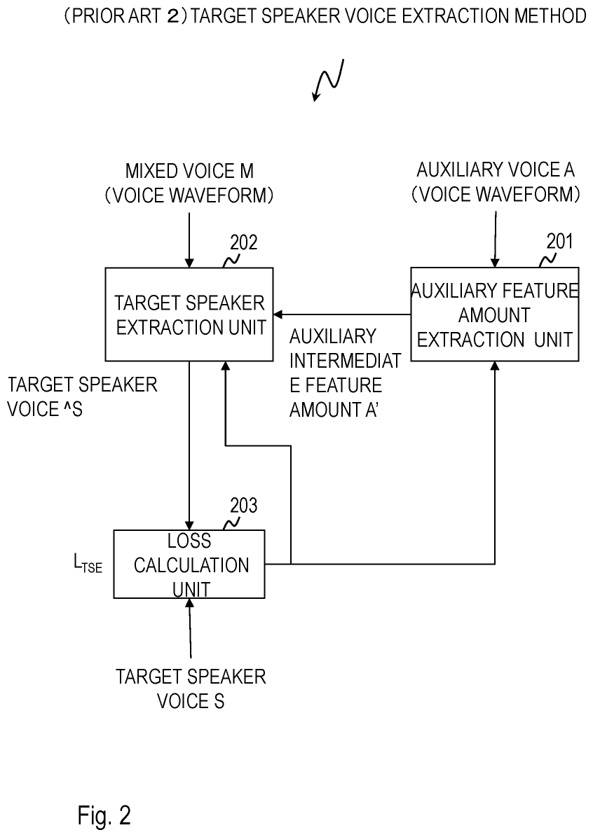

As a method for extracting a voice of a target speaker from a mixed sound which is a voice of a plurality of speakers, “Speaker Beam” of Non Patent Literature 2 is known (hereinafter, this method is also referred to as “Prior Art 2”). FIG. 2 is a functional configuration diagram of a target speaker voice extraction apparatus using this method.

An auxiliary voice A, which is a voice waveform of the prerecorded utterance of the target speaker and is used as an utterance serving as a clue for extracting the target speaker, is input to an auxiliary feature amount extraction unit 201 having a multilayer neural network function and is converted into an auxiliary intermediate feature amount A′ which is an acoustic feature amount used for extracting the target speaker.

A mixed voice M, which is a voice waveform including a plurality of spoken voices, and the auxiliary intermediate feature amount A′ are input to a target speaker extraction unit 202 having a multilayer neural network function, and the target speaker extraction unit 202 extracts a target speaker voice \hat{ }S, which is the voice of the target speaker, from the mixed voice M using the auxiliary intermediate feature amount A′ as a clue.

The extracted target speaker voice \hat{ }S is input to a loss calculation unit 203 together with the target speaker voice S that is a voice waveform of the correct target speaker, and a loss L_{TSE} is calculated from a predetermined calculation formula using them. The calculated loss L_{TSE} is used to update the model parameters of the auxiliary feature amount extraction unit 201 and the target speaker extraction unit 202. Learning is performed to more correctly extract the voice of the target speaker from the mixed voice by repeating the update of the model parameters described above.

### First Embodiment

Hereinafter, an embodiment of the present disclosure will be described in detail with reference to the drawings.

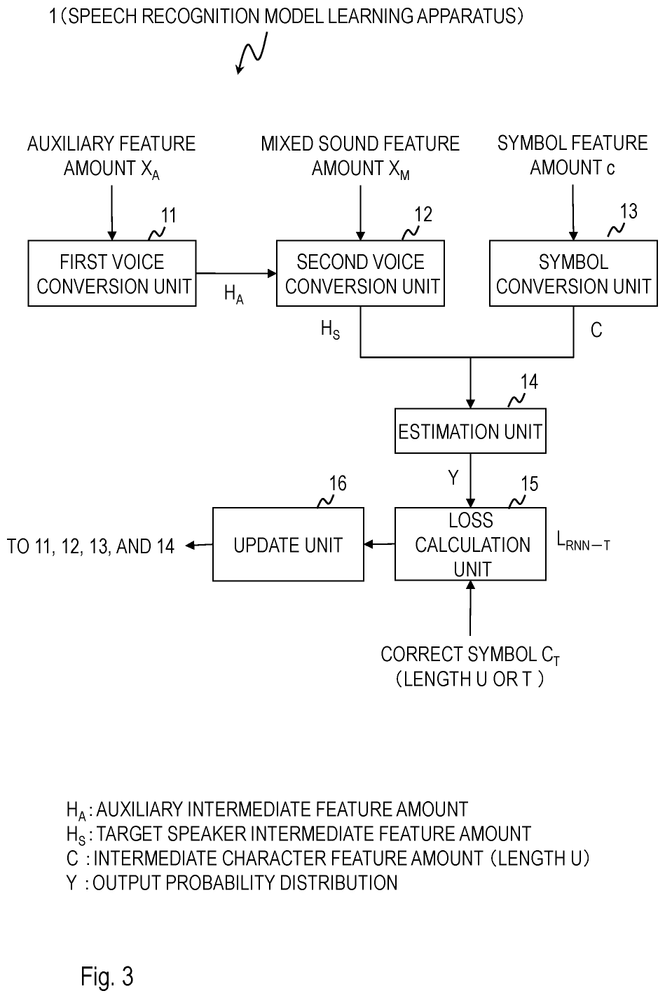

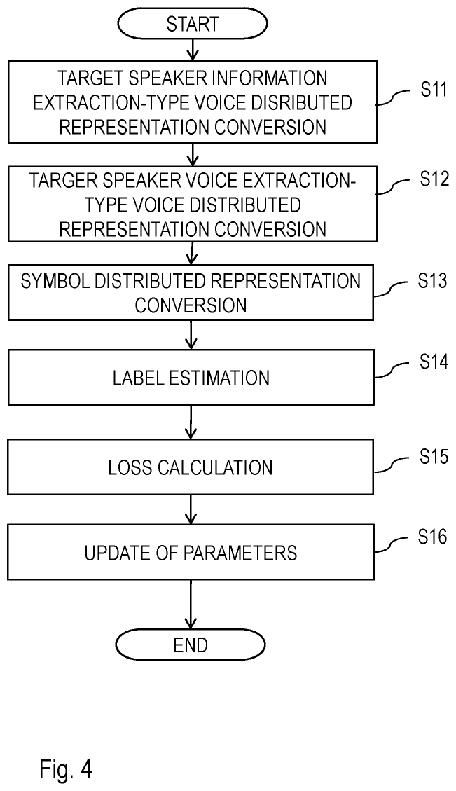

As illustrated in FIG. 3, the speech recognition model learning apparatus 1 includes a first voice conversion unit 11, a second voice conversion unit 12, a symbol conversion unit 13, an estimation unit 14, a loss calculation unit 15, and an update unit 16. The speech recognition model learning apparatus 1 includes a multistage and multilayered neutral network as a whole. The speech recognition model learning apparatus 1 performs the speech recognition model learning method of the present embodiment by performing the processing flow illustrated in FIG. 4.

### (First Voice Conversion Unit 11)

The first voice conversion unit 11 is a target speaker information extraction-type voice distributed representation sequence conversion unit. That is, the first voice conversion unit 11 converts the auxiliary feature amount X_{A}, which is a feature amount sequence of the voice of the target speaker, into an auxiliary intermediate feature amount H_{A}, which is an intermediate acoustic feature amount of the target speaker information, using a multilayer neural network (first multilayer neural network) (step S11). Here, the auxiliary feature amount X_{A} is a sequence of acoustic feature amounts extracted from the utterance of the target speaker recorded in advance, and is a sequence of acoustic feature amounts of a voice (this voice is also referred to as “target speaker information”) used as a clue for extracting the target speaker. That is, unlike the auxiliary feature amount extraction unit 201 to which the voice waveform is input in Prior Art 2, the first voice conversion unit 11 serves as an encoder that converts a sequence of acoustic feature amounts of the target speaker extracted for speech recognition into intermediate acoustic feature amounts of the target speaker information by inputting the series into a multilayer neural network.

The first voice conversion unit 11 performs conversion using a formula corresponding to the following expressions.

$${H}^{{target}^{′}} = {f}^{Spk - {Enc}^{′}} ( {f}^{FE} ( {A}^{clue} ) ; {θ}^{Spk - {Enc}^{′} ) ,} \qquad [ Math . 3 ]$$

$${h}^{{target}^{′}} = \frac{1}{T} {{\sum }^{T}}_{t = 1} {h}_{t}^{{target}^{′}} , \qquad [ Math . 4 ]$$

Here, H^{target′} is an auxiliary intermediate feature amount sequence having a length T from which the auxiliary intermediate feature amount H_{A} is a source, f^{Spk-Enc′}(⋅) is a speaker encoder (the first multilayer neural network described above), f^{FE}(⋅) is a feature extraction function, A^{clue} is the auxiliary voice A described in Prior Art 2, θ^{Spk-Enc′} is a learnable (updatable) parameter in the first voice conversion unit 11, h^{target′} is the auxiliary intermediate feature amount H_{A}, and hₜ^{target′} is the auxiliary intermediate feature amount at the time t.

### (Second Voice Conversion Unit 12)

The second voice conversion unit 12 is a target speaker voice extraction-type voice distributed representation sequence conversion unit. That is, the second voice conversion unit 12 receives, as inputs, the auxiliary intermediate feature amount H_{A}, which is the intermediate feature amount of the target speaker information, and the mixed sound feature amount X_{M}, which is the feature amount sequence of the mixed voice in which the voices of the plurality of speakers are mixed, and converts the feature amounts into the target speaker intermediate feature amount H_{S}, which is the sequence of the intermediate acoustic feature amount of the target speaker using a multilayer neural network (second multilayer neural network) (step S12).

Unlike the target speaker extraction unit 202 that has input the voice waveform, the second voice conversion unit 12 converts the mixed sound feature amount X_{M}, which is a sequence of acoustic feature amounts of mixed voices including a plurality of speakers extracted for speech recognition, into the target speaker intermediate feature amount H_{S}, using a multilayer neural network different from the first voice conversion unit 11.

In the present embodiment, it is assumed that the target speaker intermediate feature amount H_{S} includes only voice information of the target speaker. Therefore, as subsequent processing, a speech recognition learning function for estimating a symbol sequence of a target speaker can be provided similarly to the processing of the symbol conversion unit 102, the estimation unit 103, and the loss calculation unit 104 described in Prior Art 1.

The second voice conversion unit 12 performs conversion using a formula corresponding to the following expressions.

$${h}_{t}^{{ASR}^{′}} = {\int }^{ASR - {Enc}^{′}} ( {f}^{FE} ( {x}_{{t}^{′}} ) , {h}^{{target}^{′}} ; {θ}^{ASR - {Enc}^{′}} ) , \qquad [ Math . 5 ]$$

Here, hₜ^{ASR′} is a target speaker intermediate feature amount H_{S}, f^{ASR-Enc′} is an encoder (the above-described second multi-layer network) of the second voice conversion unit 12, F^{FE}(⋅) is the feature extraction function, x_{t′} is the mixed voice (corresponding to the mixed voice M of Prior Art 2) at the time t′, h^{target′} is the auxiliary intermediate feature amount H_{A}, and θ^{ASR-Enc′} is a learnable (updatable) parameter in the second voice conversion unit 12.

### (Symbol Conversion Unit 13)

The symbol conversion unit 13 converts the symbol feature amount c of the length U, which is a symbol sequence of the target speaker, into an intermediate character feature amount C, which is a sequence of feature amounts of corresponding continuous values, using a multilayer neural network (third multilayer neural network) (step S13). That is, the symbol conversion unit 13 serves as an encoder, and an input is converted into a one-hot vector once, and then converted into the intermediate character feature amount C by a multilayer neural network. The symbol conversion unit 13 corresponds to the same function as the symbol conversion unit 102 of Prior Art 1.

### (Estimation Unit 14)

The estimation unit 14 receives, as inputs, the target speaker intermediate feature amount H_{S} and the intermediate character feature amount C and calculates an output probability distribution Y of a two-dimensional matrix corresponding to label estimation using the neural network (step S14). The estimation unit 14 corresponds to the same function as the estimation unit 103 of Prior Art 1.

Calculation of the output probability distribution Y is performed using a formula corresponding to the following expression.

$${y}_{t , u} = Softmax ( {W}_{3} ( tanh ( {W}_{1} {h}_{t} + {W}_{2} {c}_{u} + b ) ) ) , \qquad [ Math . 6 ]$$

Here, y_{t,u} is an output probability distribution in a case where the auxiliary feature amount hₜ and the u-th symbol feature amount cᵤ at the time t are input, W₁ is a weight of the hidden layer with respect to the input auxiliary feature amount hₜ, W₂ is a weight of the hidden layer with respect to the input symbol feature amount cᵤ, b is a bias, W₃ is a weight of the hidden layer with respect to the input tanh (W₁hₜ+W₂cᵤ+b), and Softmax is an activation function.

In addition, in the above expression, since the lengths of t and u are different, there is a dimension of the number of elements of the neural network in addition to t and u, and thus, it is three-dimensional. Specifically, at the time of addition, W₁H copies the same value in the dimension direction of U and extends to a three-dimensional tensor. W₂C copies the same value in the dimension direction of T to expand to a three-dimensional tensor. Since the three-dimensional tensors are added, the output also becomes a three-dimensional tensor.

Generally, at the time of learning of RNN-T, learning is performed by RNN-T loss on the assumption that a tensor is three-dimensional. However, at the time of inference that is the processing of the estimation unit 14, since there is no expansion operation, the output is a two-dimensional matrix.

### (Loss Calculation Unit 15)

The loss calculation unit 15 receives, as inputs, the correct symbol Cr (of the length U or the length T) that is a symbol sequence of the target speaker corresponding to the correct data and the output probability distribution Y that is a three-dimensional tensor, and calculates a loss L_{RNN-T} corresponding to an error of the output probability distribution Y (step S15). The loss calculation unit 15 corresponds to a function equivalent to the processing function of loss calculation performed by the loss calculation unit 104 of Prior Art 1.

In the calculation of the loss L_{RNN-T}, for example, a tensor is created with the vertical axis as the symbol sequence length U, the horizontal axis as the input sequence length T, and the depth as the number of classes, that is, the number of symbol entries K, and a path of an optimal transition probability in the plane of U×T is calculated based on the forward backward algorithm. Details of the calculation are described, for example, in Chapter 2 “2. Recurrent Neural Network Transducer” of Non Patent Literature 1 described above.

### (Update Unit 16)

The update unit 16 updates the model parameters of the first voice conversion unit 11, the second voice conversion unit 12, the symbol conversion unit 13, and the estimation unit 14 using the loss L_{RNN-T} (step S16). The update unit 16 corresponds to a function similar to the model parameter update function performed by the loss calculation unit 104 of Prior Art 1.

The speech recognition model learning apparatus 1 performs learning so that correct speech recognition can be performed by repeating the above-described update of the model parameters.

The effects of the speech recognition model learning apparatus 1 according to the present embodiment can be expected to be the effects described in Non Patent Literature 1 and Non Patent Literature 2 described above. That is, the calculation processing amount is considered to be equivalent to that of the conventional speech recognition apparatus such as Non Patent Literature 1. Furthermore, the recognition performance of speech recognition is considered to be equivalent to, for example, a result obtained by combining Prior Art 1 and Prior Art 2. Therefore, it is possible to realize the speech recognition of the target speaker while dramatically reducing the calculation amount as compared with the case of simply extracting the target voice using Prior Art 2 and then performing the speech recognition processing using Prior Art 1.

Therefore, according to the present disclosure, a voice of a target speaker can be recognized in real time from among mixed voices including utterances of a plurality of speakers.

### Modification Example of First Embodiment

In the first embodiment, it is assumed that the acoustic feature amount of the target speaker is always included in the mixed sound feature amount X_{M}. However, it is also assumed that the actual mixed sound does not include the acoustic feature amount of the target speaker. Therefore, if a situation equivalent to a case where the acoustic feature amount of the target speaker is not included in the mixed voice is realized, and under the situation, learning can be performed to output a symbol indicating that the target speaker is not included, it is possible to create a learning model that operates more robustly.

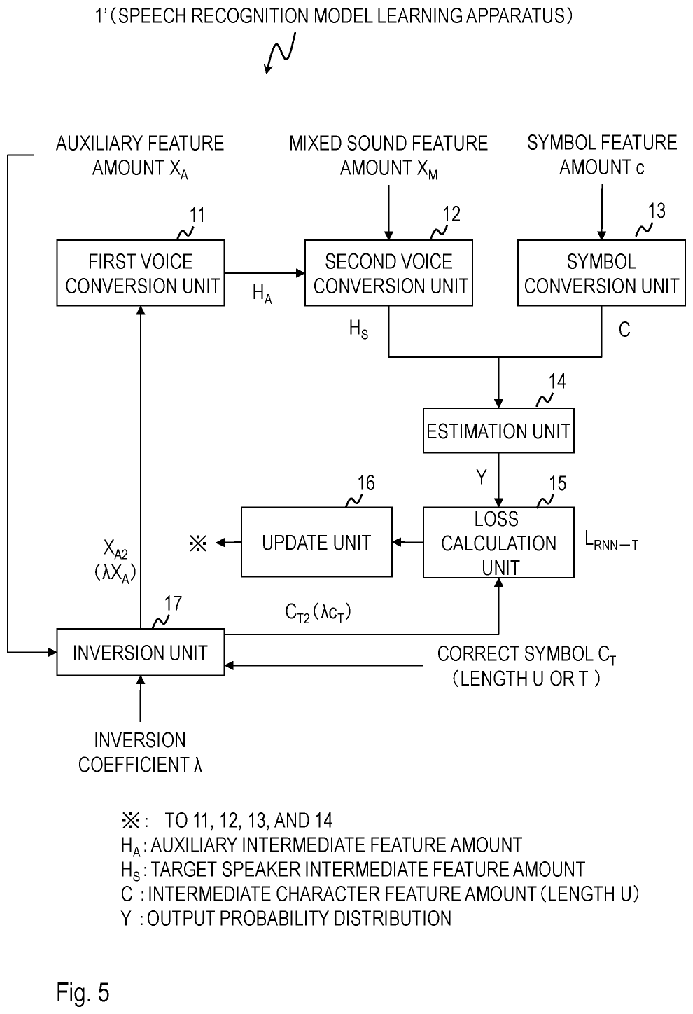

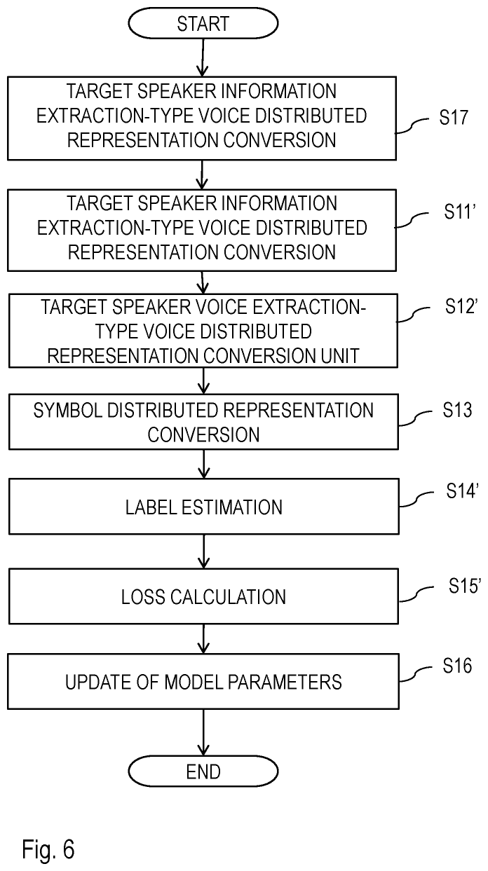

In order to incorporate the above function, the above-described speech recognition model learning apparatus 1 may be configured as a speech recognition model learning apparatus 1′ in FIG. 5. The speech recognition model learning apparatus 1′ is different from the speech recognition model learning apparatus 1 of FIG. 3 in that an inversion unit 17 is newly provided. Accordingly, the flowchart of FIG. 4 is changed as illustrated in FIG. 6. That is, before step S11, step S17 is added, step S11 is changed to step S11′, step S12 is changed to step S12′, step S14 is changed to step S14′, and step S15 is changed to step S15′.

As illustrated in FIGS. 5 and 6, the inversion unit 17 receives the auxiliary feature amount X_{A} and the inversion coefficient λ as inputs and generates a second auxiliary feature amount X_{A2} (=λX_{A}). The inversion unit 17 receives a correct symbol C and an inversion coefficient A as inputs, and generates a second correct symbol C_{T2} (=λC_{T}). The inversion unit 17 outputs the second auxiliary feature amount X_{A2} to the first voice conversion unit 11 and outputs the second correct symbol C_{T2} to the loss calculation unit 15. The inversion coefficient A is a preset coefficient that satisfies a condition of 0≤λ≤1. In a case where the inversion coefficient λ=0, the inversion unit 17 outputs the auxiliary feature amount X_{A} and the correct symbol C_{T}, which are inputs, without performing conversion. When the inversion coefficient λ≠0, the inversion unit 17 converts the auxiliary feature amount X_{A} depending on the magnitude of the inversion coefficient A and outputs the converted auxiliary feature amount X_{A}. Further, the inversion unit 17 converts the correct symbol C_{T} depending on the magnitude of the inversion coefficient λ and outputs the converted correct symbol C_{T} (step S17).

The first voice conversion unit 11 performs conversion processing of the first voice conversion unit 11 by replacing the sequence used for conversion in step S11 from the auxiliary feature amount X_{A} to the second auxiliary feature amount X_{A2}(λX_{A}) (step S11′). In addition, the loss calculation unit 15 performs the calculation processing of the loss calculation unit 15 by replacing the sequence used for the calculation in step S15 from the correct symbol C_{T} to the second correct symbol C_{T2} (λC_{T}) (step S15′).

In a case where the inversion coefficient λ is not 0 (λ≠0), the second voice conversion unit 12 may not be able to find the second auxiliary feature amount X_{A2}, which is the auxiliary feature amount of the target speaker, in the mixed sound feature amount X_{M}. In this case, this fact is output to the estimation unit 14 (step S12′). In this case, the estimation unit 14 outputs a unified symbol (for example, ˜C) indicating a non-target speaker as a result of the output probability distribution Y (step S14′).

Note that, in a case where the inversion coefficient λ is set to a value close to 0 (zero), such as in a case where the inversion coefficient λ is set to 0.01, the inversion unit 17 may be configured to output without performing conversion. That is, the same content as the auxiliary feature amount X_{A} may be output to the first voice conversion unit 11 as the second auxiliary feature amount X_{A2}, and the same content as the correct symbol C_{T} may be output to the loss calculation unit as the second correct symbol C_{T2}. In this case, similarly to the apparatus that recognizes only the voice of the target speaker, the loss calculation unit 15 receives the second correct symbol C_{T2} that is the same as the original correct symbol C_{T} from the inversion unit 17, and as a result, the parameter is updated by the processing of the update unit 16.

According to the present modification example, it is possible to realize a framework that does not more explicitly recognize a voice other than the target speaker. In this modification example, a voice of a target speaker can be recognized in real time from among mixed voices including utterances of a plurality of speakers.

Furthermore, in the present modification example, a part of the learning data can be learned in the case of the inversion coefficient λ≠0. By performing such learning, it is possible to perform more robust model learning than the first embodiment.

Various kinds of processing in the first embodiment and the modification example of the first example described above may be executed not only in time series in accordance with the description but also in parallel or individually in accordance with processing abilities of the apparatuses that execute the processing or as necessary. For example, step S12 and step S13 may be processed in parallel, or the processing of step S13 may be performed before step S12. In addition to the above, it is needless to say that appropriate modifications can be made without departing from the scope of the present invention.

### [Program and Recording Medium]

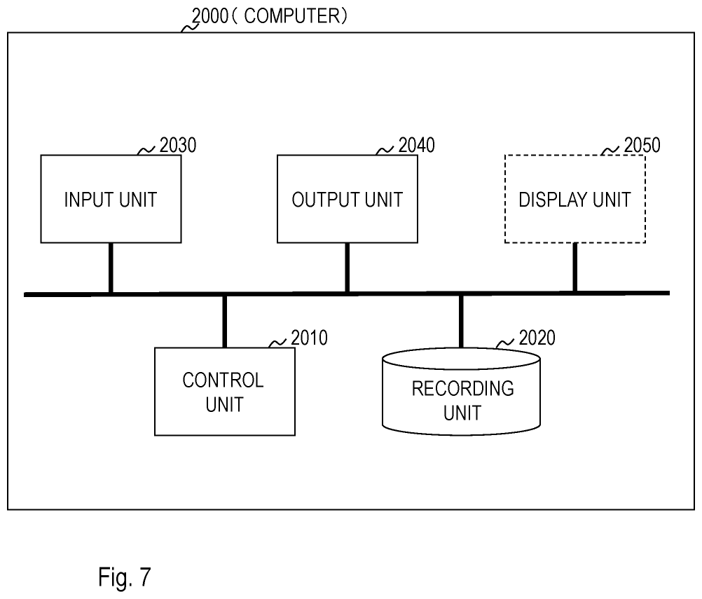

The various kinds of processing described above can be performed by causing a recording unit 2020 of a computer 2000 illustrated in FIG. 7 to read a program for executing each step of the method described above and causing a control unit 2010, an input unit 2030, an output unit 2040, a display unit 2050, and the like to operate.

The program describing the processing content may be recorded on a computer-readable recording medium. The computer-readable recording medium may be, for example, any recording medium such as a magnetic recording device, an optical disc, a magneto-optical recording medium, or a semiconductor memory.

In addition, the program is distributed by, for example, selling, transferring, or renting a portable recording medium such as a DVD and a CD-ROM in which the program is recorded. Further, the program may be stored in a storage device of a server computer, and the program may be distributed by transferring the program from the server computer to another computer via a network.

For example, the computer that executes such a program first temporarily stores the program recorded in the portable recording medium or the program transferred from the server computer in the storage device of the own computer. Then, when executing processing, the computer reads the program stored in the recording medium of the computer and executes the processing according to the read program. Moreover, as another mode of the program, the computer may read the program directly from a portable recording medium and execute processing according to the program, or alternatively, the computer may sequentially execute processing according to a received program every time the program is transferred from a server computer to the computer. Moreover, the above-described processing may be executed by a so-called application service provider (ASP) type service that implements a processing function only by an execution instruction and result acquisition without transferring the program from a server computer to the computer. Note that the program in the present embodiment includes information used for processing by an electronic computer and equivalent to the program (data or the like that is not a direct command to the computer but has property that defines processing performed by the computer).

In addition, although the present apparatuses are each configured by executing a predetermined program on a computer in this form, at least a part of the processing content may be implemented by hardware.

1. A speech recognition model learning apparatus comprising:
processing circuitry configured to:
execute a first voice conversion processing that converts an auxiliary feature amount, which is a feature amount sequence of a voice of a target speaker, into an auxiliary intermediate feature amount, using a first multilayer neural network;
execute a second voice conversion processing that receives, as inputs, the auxiliary intermediate feature amount and a mixed sound feature amount which is a feature amount sequence of voices of a plurality of speakers and converts the auxiliary intermediate feature amount and the mixed sound feature amount into a target speaker intermediate feature amount that is an intermediate feature amount sequence of the target speaker using a second multilayer neural network;
execute a symbol conversion processing that converts a symbol feature amount that is a symbol sequence of the target speaker into an intermediate character feature amount that is a feature amount of corresponding continuous values, using a third multilayer neural network;
execute an estimation processing that receives, as inputs, the target speaker intermediate feature amount and the intermediate feature amount sequence and calculates an output probability distribution of a two-dimensional matrix for label estimation using a neural network;
execute a loss calculation processing that receives, as inputs, a correct symbol that is a symbol sequence of the target speaker corresponding to correct data and an output probability distribution and calculates a loss corresponding to an error of the output probability distribution; and
execute an update processing that updates model parameters of the first voice conversion processing, the second voice conversion processing, the symbol conversion processing, and the estimation processing using the loss.

2. The speech recognition model learning apparatus according to claim 1, wherein in a case where H^{target′} is an auxiliary intermediate feature amount sequence of a length T that is a source of the auxiliary intermediate feature amount, f^{Spk-Ene′}(⋅) is the first multilayer neural network, f^{FE}(⋅) is a feature extraction function, A^{clue} is a voice waveform of an auxiliary voice that is a source of the auxiliary feature amount, A^{Spk-Enc′} is an updatable parameter in the first voice conversion processing, h^{target′} is the auxiliary intermediate feature amount, and hₜ^{target′} is the auxiliary intermediate feature amount at time t, the first voice conversion processing performs conversion using the following expressions;
$${H}^{{target}^{′}} = {f}^{Spk - {Enc}^{′}} ( {f}^{FE} ( {A}^{clue} ) ; {θ}^{Spk - {Enc}^{′}} ) , and$$
$${h}^{{target}^{′}} = \frac{1}{T} {{\sum }^{T}}_{t = 1} {h}_{t}^{{target}^{′}} [ [ , ] ] .$$

3. The speech recognition model learning apparatus according to claim 2, wherein in a case where hₜ^{ASR′} is the target speaker intermediate feature amount, f^{ASR-Enc′} is the second multilayer neural network, f_{FE}(⋅) is a feature extraction function, x_{t′} is a voice waveform of a mixed sound that is a source of the mixed sound feature amount in a case of time t′, h^{target′} is the auxiliary intermediate feature amount, and θ^{ASR-Enc′} is an updatable parameter in the second voice conversion processing, the second voice conversion processing performs conversion using the following expression:
$${h}_{t}^{{ASR}^{′}} = {f}^{ASR - {Enc}^{′}} ( {f}^{FE} ( {x}_{{t}^{′}} ) , {h}^{{target}^{′}} ; {θ}^{ASR - {Enc}^{′}} ) [ [ , ] ] .$$

4. The speech recognition model learning apparatus according to claim 1, wherein the symbol conversion processing converts temporarily into a one-hot vector and then converts into the intermediate character feature amount by the third neural network.

5. The speech recognition model learning apparatus according to claim 1, wherein in a case where hₜ is the auxiliary feature amount at time t, cᵤ is the u-th symbol feature amount, W₁ is a weight of a hidden layer for an input hₜ, W₂ is a weight of the hidden layer for an input cᵤ, b is a bias, W₃ is a weight of the hidden layer for an input tanh (W₁hₜ+W₂cᵤ+b), Softmax is an activation function, and y_{t,u} is an output probability distribution, the estimation processing performs label estimation using the following expression:
$${y}_{t , u} = Softmax ( {W}_{3} ( tanh ( {W}_{1} {h}_{t} + {W}_{2} {c}_{u} + b ) ) ) [ [ , ] ] .$$

6. The speech recognition model learning apparatus according to claim 1,
the processing circuitry further configured to:
execute an inversion processing, wherein
the inversion processing generates a second auxiliary feature amount using the auxiliary feature amount and an inversion coefficient, and generates a second correct symbol using the correct symbol and the inversion coefficient,
the first voice conversion processing replaces a sequence used for conversion from the auxiliary feature amount to a second auxiliary feature amount,
the loss calculation processing replaces a sequence used for calculation from the correct answer symbol to a second correct symbol,
in a case where the second voice conversion processing cannot find the second auxiliary feature amount in the mixed sound feature amount, the second voice conversion processing outputs a fact that the second auxiliary feature amount cannot be found, and
the estimation processing outputs a symbol indicating a non-target speaker as a result of the output probability distribution Y in a case where the input of the fact is received.

7. A speech recognition model learning method comprising:
receiving an auxiliary feature amount that is an acoustic feature amount sequence of a voice of a target speaker as an input, and converting the auxiliary feature amount into an auxiliary intermediate feature amount, using a first multilayer neural network;
receiving, as inputs, the auxiliary intermediate feature amount and a mixed sound feature amount that is a feature amount sequence of voices of a plurality of speakers, and converting the auxiliary intermediate feature amount into a target speaker intermediate feature amount that is an intermediate feature amount sequence of the target speaker using a second multilayer neural network;
receiving a symbol feature amount that is a symbol sequence of the target speaker as an input and converting the symbol feature amount into an intermediate character feature amount that is a feature amount of corresponding continuous values, using a third multilayer neural network;
receiving the target speaker intermediate feature amount and the intermediate character feature amount as inputs and calculating an output probability distribution of a two-dimensional matrix for label estimation using a neural network;
receiving a correct symbol that is a symbol sequence of the target speaker corresponding to correct data and an output probability distribution as inputs and calculating a loss corresponding to an error of the output probability distribution; and
updating model parameters used by the first multilayer neural network, the second multilayer neural network, the third multilayer neural network, and the neural network using the loss.

8. A non-transitory computer recording medium on which a program for causing a computer to function the speech recognition model learning apparatus according to claim 1.

9. A non-transitory computer recording medium on which a program for causing a computer to function the speech recognition model learning apparatus according to claim 2.

10. A non-transitory computer recording medium on which a program for causing a computer to function the speech recognition model learning apparatus according to claim 3.

11. A non-transitory computer recording medium on which a program for causing a computer to function the speech recognition model learning apparatus according to claim 4.

12. A non-transitory computer recording medium on which a program for causing a computer to function the speech recognition model learning apparatus according to claim 5.

13. A non-transitory computer recording medium on which a program for causing a computer to function the speech recognition model learning apparatus according to claim 6.
